(19) United States
(12) Patent Application Publication
(10) Pub. No.: US 2023/0401582 A1
(43) Pub. Date: Dec. 14, 2023

(54) IDENTIFYING ACCURATE LOCATIONS OF IN-PERSON PAYMENT CARD TRANSACTIONS TO DETECT LOCATION-BASED PAYMENT CARD ANOMALIES

(71) Applicant: NortonLifeLock Inc., Tempe, AZ (US)

(72) Inventors: Kevin Alejandro Roundy, El Segundo, CA (US); Platon Kotzias, Athens (GR)

(21) Appl. No.: 17/853,011

(22) Filed: Jun. 29, 2022

(30) Foreign Application Priority Data
Jun. 14, 2022 (EP) 22386037.0

(51) Int. Cl. G06Q 20/40; G06Q 30/02; G06Q 20/34

(52) U.S. Cl. CPC G06Q 20/4015; G06Q 30/0201; G06Q 20/354

(57) ABSTRACT

Systems and methods for identifying accurate locations of in-person payment card transactions to detect location-based payment card anomalies. Some embodiments disclosed herein may enable identifying accurate locations of in-person payment card transactions to detect location-based payment card anomalies. In some embodiments, purchase data for a plurality financial transaction by a consumer that are performed in-person with a payment card may be received. The purchase data may identify merchant locations that are associated with each financial transaction. The merchant locations may be analyzed to determine whether they represent true physical locations of the financial transactions. Once a plurality of true physical locations has been identified, distances between them may be determined and a security action may be performed if the distances exceed a threshold.

### CROSS-REFERENCE TO A RELATED APPLICATION

This patent application claims the benefit of and priority to European Patent Application No. EP22386037.0, filed on Jun. 14, 2022, the contents of which are incorporated by reference.

### BACKGROUND

The ability to identify accurate locations for in-person payment card transactions is essential for determining location-based payment card transaction anomalies. Financial institutions report details of payment card transactions; however, these details often fail to explicitly identify any location. To the extent that a location is not included within the details of a payment transaction reported by a financial institution, the details provided by a financial institution may be submitted to third-party data aggregators. These third-party data aggregators may identify a transaction location based on the details of payment card transactions, which are reported by financial institutions.

Unfortunately, the locations identified in details of payment card transactions reported by financial institutions and identified by third-party aggregators do not reliably identify true physical locations of transactions. Often, the location of a company's corporate headquarters is identified instead of the location of an individual store or franchise, where the transaction actually occurs. This is especially true for merchants that have many in-person retail locations and that provide a mix of in-person and online transactions, which are more naturally represented by a corporate address.

The challenges associated with identifying accurate locations of in-person payment card transactions make it very difficult to reliably detect payment card anomalies that are based on the locations of these transactions.

The subject matter claimed herein is not limited to embodiments that solve any disadvantages or that operate only in environments such as those described above. Rather, this background is only provided to illustrate one example technology area where some embodiments described herein may be practiced.

### SUMMARY

In one embodiment, a computer-implemented method for identifying accurate locations of in-person payment card transactions to detect location-based payment card anomalies may be performed, at least in part, by a computing device including one or more processors. The method may include receiving purchase data for a new financial transaction by a consumer with a merchant that is performed in-person with a payment card, wherein the purchase data identifies the merchant and a merchant location that is associated with the new financial transaction; receiving merchant data that includes a number of locations where the merchant transacts business and historical financial transaction data with the merchant, wherein the historical financial transaction data identifies a location, within the number of locations, where each historical financial transaction is reported to have been performed; selecting, from the merchant data, a number of historical financial transactions to determine a frequency at which historical financial transactions are reported to have been performed at the merchant location that is associated with the new financial transaction; calculating a probability that the merchant location that is associated with the new financial transaction is a true physical location of the new financial transaction, wherein the probability calculation uses the frequency at which the historical financial transactions are reported to have been performed at the merchant location that is associated with the new financial transaction and a probability value that is based, at least in part, on the number of locations where the merchant transacts business; and determining that the merchant location that is associated with the new financial transaction is the true physical location of the new financial transaction when the probability calculated is more than an identified probability threshold.

In some embodiments, the purchase data may include an “isPhysical” bit and the new financial transaction may be determined to be in-person based on a positive “isPhysical” bit.

In some embodiments, the merchant location within the purchase data and the number of locations where each historical financial transaction is reported to have been performed within the merchant data may be identified by at least one of a state, a city, or a zip code.

In some embodiments, the probability value may weigh each of the number of locations where the merchant transacts business equally so that there is an equal probability that a transaction occurs at each of the locations where the merchant transacts business. In alternative embodiments, the probability value for each of the locations where the merchant transacts business may be adjusted to account for a population density of each location within the number of locations where the merchant transacts business.

In some embodiments, the probability calculation may use a binomial cumulative distribution function to calculate the probability that the merchant location that is associated with the new financial transaction is the true physical location of the new financial transaction.

In some embodiments, where the probability calculated is less than the identified threshold, the method may further comprise: receiving consumer data for a plurality of individuals that have performed an historical in-person financial transaction with the merchant, wherein the consumer data includes a reported location of non-merchant in-person financial transactions that the plurality of individuals performed on the same day as the historical financial transaction with the merchant; calculating, from the consumer data, a fraction of the non-merchant financial transactions that the plurality of individuals performed on the same day as the historical financial transaction with the merchant that have a reported location that is the same as the merchant location that is associated with the new financial transaction; and determining that the merchant location that is associated with the financial transaction is the true physical location of the financial transaction when the fraction calculated is more than an identified fraction threshold.

In some embodiments, the method may further include determining true physical locations for a plurality of financial transactions performed by the consumer in a single day; determining a distance between the true physical locations for the plurality of financial transactions; and performing a security action if the distance between two or more financial transactions within the plurality of financial transactions exceeds an identified distance threshold. In these embodiments, the security action may include providing an alert to the consumer or placing a hold on one or more of the consumer's payment cards.

In another embodiment, a computer-implemented method for identifying accurate locations of in-person payment card transactions to detect location-based payment card anomalies may be performed, at least in part, by a computing device including one or more processors. The method may include receiving purchase data for a new financial transaction by a consumer with a merchant that is performed in-person with a payment card, wherein the purchase data identifies the merchant and a merchant location that is associated with the new financial transaction; receiving consumer data for a plurality of individuals that have performed an historical in-person financial transaction with the merchant, wherein the consumer data includes a reported location of non-merchant in-person financial transactions that the plurality of individuals performed on the same day as the historical financial transaction with the merchant; calculating, from the consumer data, a fraction of the non-merchant financial transactions that the plurality of individuals performed on the same day as the historical financial transaction with the merchant that have a reported location that is the same as the merchant location that is associated with the new financial transaction; and determining that the merchant location that is associated with the financial transaction is the true physical location of the financial transaction when the fraction calculated is more than an identified fraction threshold.

In another embodiment, a computer-implemented method for identifying accurate locations of in-person payment card transactions to detect location-based payment card anomalies may be performed, at least in part, by a computing device including one or more processors. The method may include (a) receiving purchase data for a first financial transaction by a consumer with a merchant that is performed in-person with a payment card, wherein the purchase data identifies the merchant, a merchant location that is associated with the first financial transaction, and a date on which the first financial transaction occurred; (b) receiving merchant data that includes a number of locations where the merchant transacts business and historical financial transaction data with the merchant, wherein the historical financial transaction data identifies a location, within the number of locations, where each historical financial transaction is reported to have been performed; (c) selecting, from the merchant data, a number of historical financial transactions to determine a frequency at which historical financial transactions are reported to have been performed at the merchant location that is associated with the first financial transaction; (d) calculating a probability that the merchant location that is associated with the first financial transaction is a true physical location of the first financial transaction, wherein the probability calculation uses the frequency at which the historical financial transactions are reported to have been performed at the merchant location that is associated with the first financial transaction and a probability value that is based, at least in part, on the number of locations where the merchant transacts business; (e) receiving consumer data for a plurality of individuals that have performed an historical in-person financial transaction with the merchant, wherein the consumer data includes a reported location of non-merchant in-person financial transactions that the plurality of individuals performed on a same day as the historical financial transaction with the merchant; (f) calculating, from the consumer data, a fraction of the non-merchant financial transactions that the plurality of individuals performed on the same day as the historical financial transaction with the merchant that have a reported location that is the same as the merchant location that is associated with the first financial transaction; (g) determining that the merchant location that is associated with the first financial transaction is the true physical location of the first financial transaction if the probability calculated is more than an identified probability threshold or the fraction calculated is more than an identified fraction threshold; (h) repeating steps (a)-(g) for a second financial transaction by the consumer with another merchant that is performed in-person with the payment card on the date on which the first financial transaction occurred to determine a true physical location for the second financial transaction; (i) determining a distance between the true physical locations of the first and second financial transactions; and (j) performing a security action if the distance between the true physical locations of the first and second financial transactions exceeds an identified distance threshold.

Also, in some embodiments, one or more non-transitory computer-readable media may include one or more computer-readable instructions that, when executed by one or more processors of a computing device, cause the computing device to perform a method for identifying accurate locations of in-person payment card transactions to detect location-based payment card anomalies.

Further, in some embodiments, a computing device comprising one or more processors and one or more non-transitory computer-readable media comprising one or more computer-readable instructions that, when executed by the one or more processors, may cause the computing device to perform a method for identifying accurate locations of in-person payment card transactions to detect location-based payment card anomalies.

It is to be understood that both the foregoing summary and the following detailed description are explanatory and are not restrictive of the invention as claimed.

### BRIEF DESCRIPTION OF THE DRAWINGS

Embodiments will be described and explained with additional specificity and detail through the use of the accompanying drawings in which:

FIG. 1 illustrates an example system configured for identifying accurate locations of in-person payment card transactions to detect location-based payment card anomalies;

FIG. 2 illustrates in further detail the security application of FIG. 1;

FIGS. 3A-3B are a flowchart of an example method for identifying accurate locations of in-person payment card transactions to detect location-based payment card; and

FIG. 4 illustrates an example computer system that may be employed in identifying accurate locations of in-person payment card transactions to detect location-based payment card anomalies.

### DETAILED DESCRIPTION

The ability to identify accurate locations for in-person payment card transactions is essential for determining location-based payment card transaction anomalies. Financial institutions, such as banks, report details of payment card transactions. These transaction details are often shown on payment card statements that are received by consumers. The transaction details provided by financial institutions are limited in several respects. First, the transaction details provided by financial institutions identify transaction dates, but often lack timestamps making it difficult to identify an exact sequence of transactions or elapsed time between transactions.

In addition, while the transaction details provided by financial institutions often include a transaction description string, these transaction description strings frequently comprise a cryptic series of letters, numbers, and symbols that may not explicitly identify any location. The following are examples of transaction description strings that may be associated with payment card transactions:
“POS TOUCHNOTE LTD CAMDEN TOWN GB”
“Point Of Sale Withdrawal MNRD-F WY 6310 ILLI FORT WAYNE INUS”
“ZAZU SALON AND DAY SHINSDALE IL XXXXXXXXXXX XXXXXX8972”
“0008 POS PURCHASE AT PIZZA HUT XX9800 GREAT BEND KS”
“SQUAW VALLEY RETAIL OLYMPIC VALLECA”
“7-ELEVEN X4162”

To the extent that a location is not included within a transaction description string, the details provided in a transaction description string may be submitted to a third-party data aggregator, such as YODLEE®. These third-party data aggregators may attempt to identify additional location information and other merchant data based on the transaction description strings provided by the financial institutions through a parallel database of merchant information. For example, a data aggregator may be able to determine that the description string “7-ELEVEN X4162” refers to a 7-ELEVEN® franchise in Coral Springs, Florida, by using “X4162” as a franchise identifier.

Unfortunately, the locations identified within transaction description strings and by third-party aggregators are not reliable to accurately identify true physical locations of transactions. Often, the location of a company's corporate headquarters is identified instead of the location of an individual store or franchise, where the transaction actually occurred. This is especially true for merchants that have many in-person retail locations (such as fast food chains) and for merchants that provide a mix of in-person locations and online transactions, which are more naturally represented by a corporate address.

The challenges associated with identifying accurate locations of in-person payment card transactions make it very difficult to reliably detect payment card anomalies that are based on the locations of these transactions.

Some embodiments disclosed herein may enable identifying accurate locations of in-person payment card transactions to detect location-based payment card anomalies. In particular, in some embodiments disclosed herein, purchase data for a new financial transaction by a consumer with a merchant that is performed in-person with a payment card may be received. The purchase data may identify the merchant and a merchant location that is associated with the new financial transaction. Merchant data that includes a number of locations where the merchant transacts business and historical financial transaction data with the merchant may also be received. The historical financial transaction data may identify a location, within the number of locations, where each historical financial transaction is reported to have been performed. A number of historical financial transactions may be selected from the merchant data to determine a frequency at which historical financial transactions are reported to have been performed at the merchant location that is associated with the new financial transaction. A probability that the merchant location that is associated with the new financial transaction is a true physical location of the new financial transaction may be calculated using the frequency at which the historical financial transactions are reported to have been performed at the merchant location that is associated with the new financial transaction and a probability value that is based, at least in part, on the number of locations where the merchant transacts business. Finally, a determination that the merchant location that is associated with the new financial transaction is the true physical location of the new financial transaction may be made when the probability calculated is more than an identified probability threshold.

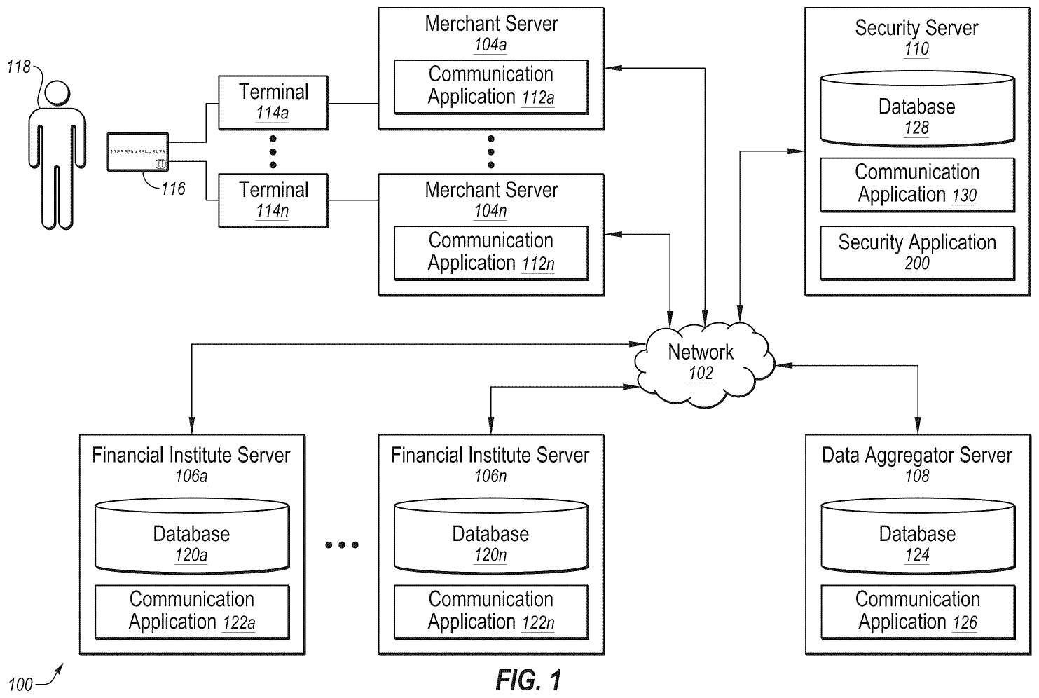

Turning to the figures, FIG. 1 illustrates an example system 100 configured for identifying accurate locations of in-person payment card transactions to detect location-based payment card anomalies. The system 100 may include a network 102, merchant servers 104a-104n, financial institute servers 106a-106n, a data aggregator server 108, and a security server 110.

In some embodiments, the network 102 may be configured to communicatively couple the merchant servers 104a-104n, the financial institute servers 106a-106n, the data aggregator server 108, and the security server 110. For example, the merchant servers 104a-104n, the financial institute servers 106a-106n, the data aggregator server 108, and the security server 110 may each include communication applications 112a-112n, 122a-122n, 126, and 130, respectively, that enable these servers to communicate with each other over the network 102. In some embodiments, the network 102 may be any wired or wireless network, or combination of multiple networks, configured to send and receive communications between systems and devices. In some embodiments, the network 102 may include a Personal Area Network (PAN), a Local Area Network (LAN), a Metropolitan Area Network (MAN), a Wide Area Network (WAN), a Storage Area Network (SAN), a cellular network, the Internet, or some combination thereof.

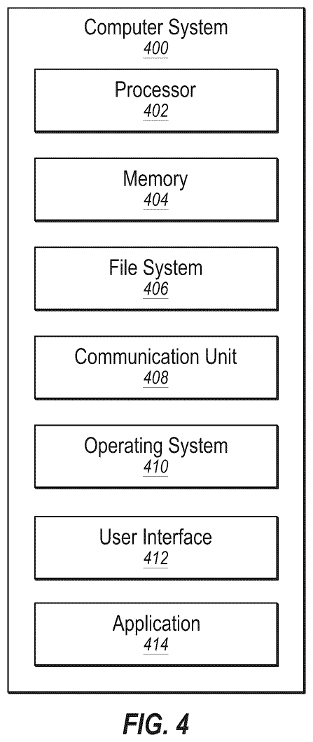

In some embodiments, the merchant servers 104a-104n may be any computer systems capable of communicating over the network 102, examples of which are disclosed herein in connection with the computer system 400 of FIG. 4. The merchant servers 104a-104n may be associated with business entities that offer for sale goods and/or services. The merchant servers 104a-104n may be communicatively coupled via a wired or wireless connection to terminals 114a-114n. These terminals 114a-114n may be used by a consumer 118 to perform a financial transaction with a business entity using a payment card 116 (such as a credit card, debit card, gift card, etc.). The terminals 114a-114n may include devices that are configured to interact with physical payment cards. For example, the terminals 114a-114n may include a magnetic strip reader, a chip reader, a contactless card reader, etc., which require a physical presence of the payment card 116. Alternatively, the terminals 114a-114n may include devices that are remote from the merchant and that simply require the consumer 118 to enter numbers from the payment card 116. For example, for online purchases, a computer connected to a merchant website over the Internet may be a terminal.

In some embodiments, the financial institute servers 106a-106n may be any computer systems capable of communicating over the network 102, examples of which are disclosed herein in connection with the computer system 400 of FIG. 4. The financial institute servers 106a-106n may be associated with financial institutes that issue payment cards to customers. For example, financial institute servers 106a-106n may be associated with banks or credit card companies that issue debit cards and credit cards to their customers. The financial institute servers 106a-106n may receive data from the merchant servers 104a-104n when payment cards, which have been issued by the financial institutes, are used in financial transactions. The data associated with the reported financial transactions may be stored by the financial institute servers 106a-106n in databases 120a-120n.

The communication applications 122a-122n may be configured to communicate data related to financial transactions performed using payment cards belonging to the consumer 118 with entities to whom the consumer 118 has authorized to receive this data. This transaction data may include a date on which the transaction was performed as well as a transaction description string, which may include a location of the transaction as well as data indicating whether the transaction was in-person. The location of the transaction may include one or more of a state, territory, province, prefecture, city, zip or other post code, or address of a payment card transaction. Data indicating whether the transaction was in-person may be based on a determination of whether the payment card was physically present at the transaction. For example, a determination that the payment card was physically present at the transaction (and therefore that the transaction was in-person) may be based on data that a magnetic strip reader or a chip reader or a contactless card reader was used to perform the transaction. Data indicating that credit card numbers were simply entered into a terminal to perform the transaction may indicate that the transaction was not in-person.

In some embodiments, the data aggregator server 108 may be any computer system capable of communicating over the network 102, examples of which are disclosed herein in connection with the computer system 400 of FIG. 4. The data aggregator server 108 may store, within a database 124, merchant information. This merchant information may be used by the data aggregator to infer a location of a payment card transaction based on transaction description strings that are provided to the data aggregator server 108. The location inferred by the data aggregator server 108 may include one or more of a state, territory, province, prefecture, city, zip or other post code, or address of a payment card transaction.

In some embodiments, the security server 110 may be any computer system capable of communicating over the network 102, examples of which are disclosed herein in connection with the computer system 400 of FIG. 4. In some embodiments, the consumer 118 may have authorized one or more financial institute servers 106a-106n to share with the security server 110 data related to financial transactions performed using one or more payment cards (such as payment card 116) that are associated with the consumer 118. The security server 110 may store this transaction data in a database 128. In addition to the consumer 118, a plurality of other consumers may also have authorized financial institutes associated with their payment cards to share financial transaction data with the security server 110. This data may also be stored in the database 128.

In some embodiments, the security server 110 may include a security application 200. The security application 200 may be configured to analyze data related to a plurality of financial transactions performed by the consumer 118 with one or more payment cards that are associated with the consumer 118 (such as payment card 116). The security application 200 may determine a true physical location of each financial transactions performed with these payment cards. The security application may then determine a distance between the true physical locations for the plurality of financial transactions. Finally, if the distance between two or more financial transactions within the plurality of financial transactions exceeds an identified distance threshold, the security application 200 may perform a security action. This security action may include providing an alert to the consumer 118 or placing a hold on one or more payment cards associated with the consumer 118. In some embodiments, the security application 200 may be, or may be part of, the NORTONLIFELOCK® Transaction Monitoring and Alerting product.

Modifications, additions, or omissions may be made to the system 100 without departing from the scope of the present disclosure. For example, in some embodiments, the system 100 may include additional components similar to the components illustrated in FIG. 1 that each may be configured similarly to the components illustrated in FIG. 1. In addition, in alternative embodiments, the databases 120a-120n, 124, and 128 may not be part of the servers in which they appear in FIG. 1. For example, one or more of these databases may be within external servers that are accessible over the network 102.

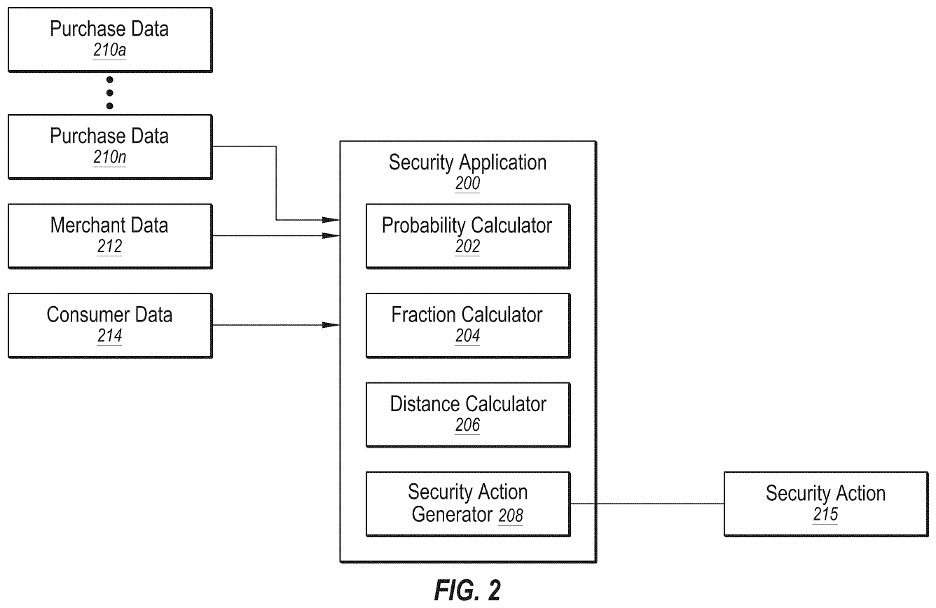

FIG. 2 illustrates the security application 200 shown as part of the security server 110 in FIG. 1. The security application 200 may include a probability calculator 202, a fraction calculator 204, a distance calculator 206 and a security action generator 208. The security application 200 may receive purchase data 210a-210n, merchant data 212, and consumer data 214.

The purchase data 210a-210n may be received from one or more of the financial institute servers 106a-106n and the data aggregator server 108, and may include data relating to a financial transaction by a consumer with a particular merchant that is performed in-person. The purchase data may be tagged with an “isPhysical” bit, which may confirm whether the transaction was performed in-person. A positive “isPhysical” bit, which indicates an in-person transaction, may be based on data that a payment card was physically present during the financial transaction. This data may include information that a magnetic strip or chip or a contactless card mechanism from the payment card 116 was used to perform the transaction.

The purchase data may also identify the particular merchant with whom the financial transaction was performed as well as a merchant location associated with the financial transaction. In some embodiments, the merchant location may be included within a transaction description string that is associated with the financial transaction and reported by one of financial institute servers 106a-106n. In alternative embodiments, the transaction description string may be used by a data aggregator to infer the merchant location. In these embodiments, a merchant address may be inferred by searching the database 124 of the data aggregator server 108 using the data provided within the transaction description string. The merchant address may include one or more of a city, state, territory, province, prefecture, zip or other post code, or address of the transaction.

The merchant data 212 may include historical purchase data from a plurality of consumers (in addition to consumer 118), who have performed one or more transaction with the particular merchant. This merchant data 212 may be searched to identify a number of locations where the merchant has previously transacted business and a location, within the number of locations, where each of these previous transaction is reported to have been performed. The probability calculator may be configured to select from the merchant data 212 a number of historical financial transactions with the particular merchant to determine a frequency at which these historical financial transactions are reported to have been performed at the merchant location that is identified in the purchase data 210a-210n.

For example, we assume first purchase data 210a is received from a financial institute that identifies an in-person financial transaction by consumer 118 with merchant APPLE®. The purchase data 210a identifies a merchant address associated with the transaction as “Cupertino, CA, 95014.” The merchant data 212 is evaluated to identify a number of merchant addresses that are associated with Apple, Inc. For purposes of this example, we assume that the merchant data 212 identifies 190 different reported transaction locations for Apple, Inc. The probability calculator 202 then selects from the merchant data 212, a number of historical financial transactions with Apple Inc. to determine a frequency at which historical financial transactions are reported to have been performed at the same merchant location that is identified in the first purchase data 210a (i.e., “Cupertino, CA, 95014”). For purposes of this example, we assume that the probability calculator identifies that out of 190 randomly selected historical financial transactions with Apple, Inc., 130 are reported to have taken place at merchant location “Cupertino, CA, 95014.”

The probability calculator 202 then measures the probability that “Cupertino, CA, 95014” would be randomly selected 130 times in 190 trials if merchant locations are randomly and uniformly selected out of the 190 possible locations. The probability of a transaction happening at merchant location “Cupertino, CA, 95014” may be modeled using a Bernoulli random variable with a probability value of p=1/190. The probability calculator 202 may then use a cumulative probability distribution of the Binomial distribution with parameters (N=190, k=130, p=1/190) to measure the probability that 130 or more of 190 independent trials would all happen at merchant location “Cupertino, CA, 95014.” This yields a probability estimate that is approximately zero.

In a second example, we assume that second purchase data 210n is received from a financial institute that again identifies an in-person financial transaction by consumer 118 with merchant Apple, Inc. In this second example, the purchase data 210n identifies a merchant address associated with the transaction as “Los Angeles, CA, 91210.” From the first example, the merchant data 212 has been evaluated and has identified 190 different transaction locations for Apple, Inc. The probability calculator 202 then selects from the merchant data 212, a number of historical financial transactions with Apple Inc. to determine a frequency at which historical financial transactions are reported to have been performed at the merchant location that is identified in the second purchase data 210n (i.e., “Los Angeles, CA, 91210”). For purposes of this second example, we assume that the probability calculator identifies that out of 190 randomly selected historical financial transactions with Apple, Inc., 5 are reported to have taken place at merchant location “Los Angeles, CA, 91210.”

The probability calculator 202 then measures the probability that “Los Angeles, CA, 91210” would be randomly selected 5 times in 190 trials if merchant locations are randomly and uniformly selected out of the 190 possible locations. The probability of a transaction happening at merchant location “Los Angeles, CA, 91210” may again be modeled using a Bernoulli random variable with a probability value of p=1/190. The probability calculator 202 may then use a cumulative probability distribution of the Binomial distribution with parameters (N=190, k=5, p=1/190) to measure the probability that 5 or more of 190 independent trials would all happen at merchant location “Los Angeles, CA, 91210.” This yields a probability estimate of approximately 0.52.

In some embodiments, the probability value may weigh each of the number of locations where the merchant transacts business equally so that there is an equal probability that a transaction occurs at each of the locations where the merchant transacts business, which can be represented by the fraction (1/# of total merchant locations). In some embodiments, the probability value may be adjusted to account for a number of different factors that may affect the popularity of a merchant location. For example, the probability value may be adjusted for an amount of time that a location has been open, a population density for the merchant location area, operating hours, etc.

The probability calculator 202 may determine that a merchant location that is reported in the purchase data 210a-210n is the true physical location of the financial transaction that is reported in the purchase data 210a-210n when the probability calculated is more than an identified probability threshold. This probability threshold may be set to any value. In some embodiments, this probability threshold may be anything more than 0.01, 0.05, or 0.1. Therefore, using any of these exemplary thresholds in the two examples above, the Cupertino merchant location would not be determined to be the true physical location of the financial transaction in the first example, while the Los Angeles merchant location would be determined to be the true physical location of the financial transaction in the second example.

The frequency-based probability modeling provided above and performed by the probability calculator 202 has limitations. It may fail to properly identify merchant locations as true physical locations in cases where the merchant has only a single physical location or a small number of locations (e.g., non-chain restaurants), and for whom all transactions may therefore be excluded as being improbably geographically distributed. To ensure that true physical location determinations for these merchants are not missed, an additional calculation may be performed.

The consumer data 214 may include historical transactions for a plurality of individuals that have performed an historical financial transaction with a particular merchant. The consumer data 214 may include a reported location of non-merchant financial transactions that the plurality of individuals performed on the same day as the historical financial transaction with the particular merchant.

For example, the consumer data 214 may identify a plurality of individuals that have performed a transaction using a payment card at a merchant having the name “Downtown Diner.” The purchase data for the Downtown Diner may identify the merchant location for these transactions as “Salt Lake City, UT, 84101.” The fraction calculator 204 may identify other in-person financial transactions by these individuals not at the Downtown Diner (“non-merchant financial transactions”) using a payment card on the same day as the transaction at the Downtown Diner and identify the transaction locations reported for these other financial transactions. The fraction calculator 204 may then calculate a fraction that these other non-merchant financial transactions, performed by the plurality of individuals on the same day as the transaction at the Downtown Diner, report “Salt Lake City, UT, 84101” as merchant locations. All financial transactions that identify “Salt Lake City, UT, 84101” as a merchant location for the Downtown Diner may be determined to be the true physical location when the fraction calculated is more than an identified fraction threshold. This fraction threshold may be set to any value. In some embodiments, this fraction threshold may be anything more than 5/10 or 6/10 or some other fraction.

In some embodiments, the probability calculator 202 and the fraction calculator 204 may be used in combination. For example, financial transaction may first be processed by the probability calculator. If the probability calculated is less than the probability threshold (and a true physical location is therefore not identified), then the financial transaction may be processed by the fraction calculator. In alternative embodiments, the probability calculator and the fraction calculator may be used independently to determine true physical locations for financial transactions.

When true physical locations for a plurality of financial transactions performed by the consumer 118 in a single day have been determined, the distance calculator 206 may determine a distance between the true physical locations for the plurality of financial transactions. Any number of different methods may be used to determine the distance between true physical locations.

In one embodiment, latitude and longitude data may be obtained by looking up (zip or other post code, city, state or territory) tuples. Using the various latitude-longitude pairs provided for transaction by a customer in a single day, distances between these transactions can be approximated on a map using latitude-longitude values as cartesian x,y coordinates. A minimum spanning tree may be calculated between the geographic points for each transaction. Anomalies may be identified when the transactions for a customer within a single day involve, for example, at least three zip codes and for which the edges in the minimum spanning tree spans more than a designated distance threshold. In one embodiment, a distance threshold may be met if the edges in the minimum spanning tree may span more than 50o latitude/longitude.

The security action generator 208 may identify an appropriate security action 215 if the distance between two or more financial transactions for a customer in a single day exceeds an identified distance threshold. The security action 215 may include providing an alert to the consumer and/or placing a hold on one or more of the consumer's payment cards.

Modifications, additions, or omissions may be made to the security application 200 without departing from the scope of the present disclosure. For example, the security application 200 may include additional components similar to the components illustrated in FIG. 2 that each may be configured similarly to the components illustrated in FIG. 2.

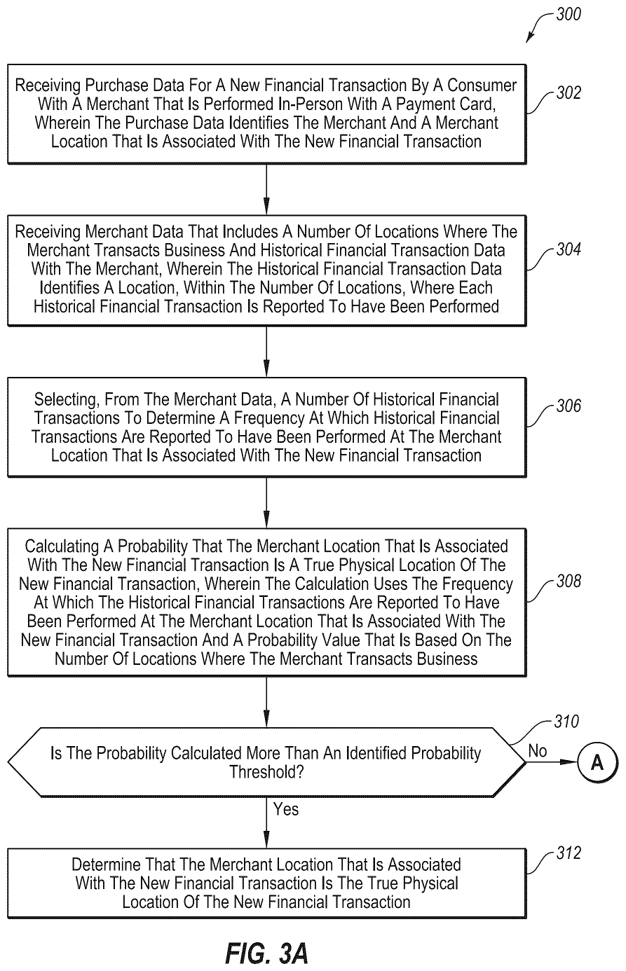

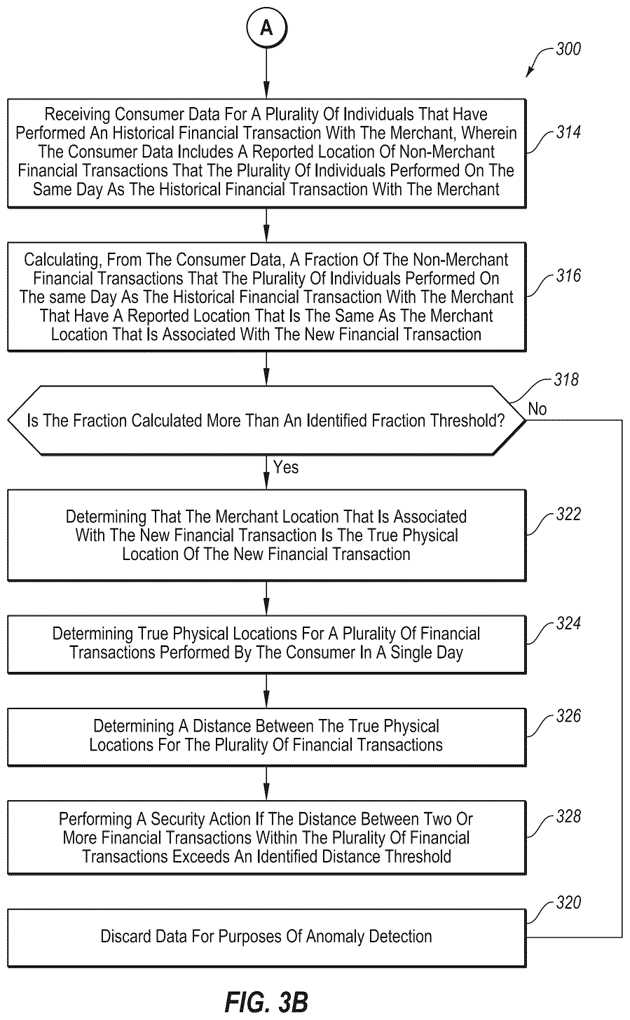

FIGS. 3A-3B are a flowchart of an example method 300 for identifying accurate locations of in-person payment card transactions to detect location-based payment card anomalies. The method 300 may be performed, in some embodiments, by a device or system, such as by the security application 200 of FIGS. 1 and 2. In these and other embodiments, the method 300 may be performed by one or more processors based on one or more computer-readable instructions stored on one or more non-transitory computer-readable media. The method 300 will now be described in connection with FIGS. 1, 2, and 3A-3B.

The method 300 may include, at action 302, receiving purchase data for a new financial transaction by a consumer with a merchant that is performed in-person with a payment card, wherein the purchase data identifies the merchant and a merchant location that is associated with the new financial transaction. To determine whether the financial transaction is performed in-person, information may be included within the purchase data that identifies whether the payment card was physically present at the transaction. For example, if a magnetic strip reader, a chip reader, a contactless card reader, etc., was used to perform the transaction, the transaction may be determined to have been in-person. The purchase data may identify the merchant location by including this location in a transaction description string. Alternatively, the data provided within a transaction description string may be correlated with a database of merchant information to identify the merchant location. The merchant location may include one or more of a state, territory, province, prefecture, city, zip or other post code, or address of the new financial transaction.

The method 300 may include, at action 304, receiving merchant data that includes a number of locations where the merchant transacts business and historical financial transaction data with the merchant, wherein the historical financial transaction data identifies a location, within the number of locations, where each historical financial transaction is reported to have been performed. For example, the historical financial transactions may be collected over any period of time and from any number of different individuals who have agreed to share this information within the merchant data.

The method 300 may include, at action 306, selecting, from the merchant data, a number of historical financial transactions to determine a frequency at which historical financial transactions are reported to have been performed at the merchant location that is associated with the new financial transaction. Any number of historical financial transactions may be selected from the merchant data. For example, hundreds or thousands of historical financial transactions performed with the merchant may be selected. To determine how many of these historical financial transactions are reported to have been performed at the merchant location, the merchant locations associated with the historical financial transactions may simply be compared with the merchant location that is reported in the purchase data.

The method 300 may include, at action 308, calculating a probability that the merchant location that is associated with the new financial transaction is a true physical location of the new financial transaction, wherein the probability calculation uses the frequency at which the historical financial transactions are reported to have been performed at the merchant location that is associated with the new financial transaction and a probability value that is based, at least in part, on the number of locations where the merchant transacts business. In one embodiment, the probability of a transaction happening at the merchant location may be modeled using a Bernoulli random variable with a probability value of that assumes an equal probability that a transaction occurs at each of the locations where the merchant transacts business, which can be represented by the fraction (1/# of total merchant locations). In other embodiments, the probability value may be adjusted to account for a number of different factors that may affect the popularity of a merchant location. For example, the probability value may be adjusted for an amount of time that a location has been open, a population density for the merchant location area, operating hours, etc.

Any probability algorithm may be used to calculate the probability that the merchant location that is associated with the new financial transaction is the true physical location of the new financial transaction. For example, the probability may be calculated using a cumulative probability distribution of the Binomial distribution to measure the probability that merchant location would be selected from the total number of location where the merchant transacts business at the frequency identified.

The method 300 may include, at action 310, determining whether the probability calculated is more than an identified probability threshold. Any probability threshold may be used. In one embodiment, a probability threshold of 0.01, 0.05, or 0.1 may be used.

If the probability calculated is more than the identified probability threshold, the method 300 may continue at action 312 where the merchant location that is associated with the new financial transaction is determined to be the true physical location of the new financial transaction.

If the probability calculated is not more than the identified probability threshold, the method 300 may include, at action 314, receiving consumer data for a plurality of individuals that have performed an historical in-person financial transaction with the merchant, wherein the consumer data includes a reported location of non-merchant in-person financial transactions that the plurality of individuals performed on the same day as the historical financial transaction with the merchant. For example, if an individual has performed a transaction with the merchant, this individual's other financial transaction on that day may be analyzed. Locations of other in-person financial transactions performed on the same day as the transaction with the merchant but not with the merchant (i.e., non-merchant transactions) may be analyzed. Locations for these non-merchant transactions may be identified.

The method 300 may include, at action 316, calculating, from the consumer data, a fraction of the non-merchant financial transactions that the plurality of individuals performed on the same day as the historical financial transaction with the merchant that have a reported location that is the same as the merchant location that is associated with the new financial transaction. To have a reported location that is the same as the merchant location may require identical city, territory, province, prefecture, state, or zip or other post codes. To determine how many of these non-merchant financial transactions are reported to have been performed at the merchant location, the merchant locations associated with the non-merchant financial transactions may simply be compared with the merchant location that is reported in the purchase data.

The method 300 may include, at action 318, determining whether the fraction calculated is more than an identified fraction threshold. Any fraction threshold may be used. In one embodiment, a fraction threshold of 0.5, 0.6, or 0.7 may be used.

If the fraction calculated is less than the identified fraction threshold, the method 300 may conclude at action 320 and the data may be discarded for purposes of anomaly detection. If the fraction calculated is more than the identified fraction threshold, the method 300 may continue at action 322 where the merchant location that is associated with the new financial transaction is determined to be the true physical location of the new financial transaction.

The method 300 may include, at action 324, determining true physical locations for a plurality of financial transactions performed by the consumer in a single day. Any method may be used to determine true physical locations for a plurality of financial transactions. In one embodiment, the probability model described in actions 304-312 may be used. In another embodiment, the fraction model described in actions 314-322 may be used. In another embodiment, the probability model and the fraction model may be used in together as provided in actions 304-322.

The method 300 may include, at action 326, determining a distance between the true physical locations for the plurality of financial transactions. Distances between true physical locations may be determined in a number of different ways. In one embodiment, cities, territories, provinces, prefectures, states, and/or zip/post codes may be compared to identify a distance separating the plurality of financial transactions. Alternatively, latitude and longitude data may be obtained by looking up (zip or other post code, city, state or territory) tuples. Using the various latitude-longitude pairs provided for transaction by a customer in a single day, distances between these transactions can be approximated on a map using latitude-longitude values as cartesian x,y coordinates. A minimum spanning tree may be calculated between the geographic points for each transaction.

The method 300 may include, at action 328, performing a security action if the distance between two or more financial transactions within the plurality of financial transactions exceeds an identified distance threshold. Any distance threshold may be used. For example, in one embodiment, a distance threshold may be met if the edges in a minimum spanning tree may span more than 50o latitude/longitude. The security action performed if the distance between financial transactions exceeds a distance threshold may include providing a notice to the consumer and/or placing a hold on one or more of the consumers payment cards.

Although the actions of the method 300 are illustrated in FIGS. 3A-3B as discrete actions, various actions may be divided into additional actions, combined into fewer actions, reordered, expanded, or eliminated, depending on the desired implementation. For example, in some embodiments, actions 314 to 322 may be skipped and true physical locations for a plurality of financial transactions may be identified based solely on actions 304-312. In other embodiments, actions 304-312 may be skipped and true physical locations for a plurality of financial transactions may be identified based solely on actions 314-322.

Further, it is understood that the method 300 may improve the technical field of payment card anomaly detection based on transaction locations. By identifying reliably accurate transaction locations, payment card anomalies that are based on locations of the transactions may be identified with more confidence and precision.

FIG. 4 illustrates an example computer system that may be employed in identifying accurate locations of in-person payment card transactions to detect location-based payment card anomalies. In some embodiments, the computer system 400 may be part of any of the systems or devices described in this disclosure. For example, the computer system 400 may be part of any of the merchant servers 104a-104n, the financial institute servers 106a-106n, the data aggregator server 108, and the security server 110.

The computer system 400 may include a processor 402, a memory 404, a file system 406, a communication unit 408, an operating system 410, a user interface 412, and an application 414, which all may be communicatively coupled. In some embodiments, the computer system may be, for example, a desktop computer, a client computer, a server computer, a mobile phone, a laptop computer, a smartphone, a smartwatch, a tablet computer, a portable music player, a networking device, or any other computer system.

Generally, the processor 402 may include any suitable special-purpose or general-purpose computer, computing entity, or processing device including various computer hardware or software applications and may be configured to execute instructions stored on any applicable computer-readable storage media. For example, the processor 402 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data, or any combination thereof. In some embodiments, the processor 402 may interpret and/or execute program instructions and/or process data stored in the memory 404 and/or the file system 406. In some embodiments, the processor 402 may fetch program instructions from the file system 406 and load the program instructions into the memory 404. After the program instructions are loaded into the memory 404, the processor 402 may execute the program instructions. In some embodiments, the instructions may include the processor 402 performing one or more of the actions of the methods disclosed herein.

The memory 404 and the file system 406 may include computer-readable storage media for carrying or having stored thereon computer-executable instructions or data structures. Such computer-readable storage media may be any available non-transitory media that may be accessed by a general-purpose or special-purpose computer, such as the processor 402. By way of example, and not limitation, such computer-readable storage media may include non-transitory computer-readable storage media including Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage media which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 402 to perform a certain operation or group of operations, such as one or more of the actions of the methods disclosed herein. These computer-executable instructions may be included, for example, in the operating system 410, in one or more applications, such as the communication applications 112a-112n, 122a-122n, 126, and 130, the security application 200 of FIGS. 1 and 2, or in some combination thereof.

The communication unit 408 may include any component, device, system, or combination thereof configured to transmit or receive information over a network, such as the network 102 of FIG. 1. In some embodiments, the communication unit 408 may communicate with other devices at other locations, the same location, or even other components within the same system. For example, the communication unit 408 may include a modem, a network card (wireless or wired), an infrared communication device, a wireless communication device (such as an antenna), and/or chipset (such as a Bluetooth device, an 802.6 device (e.g., Metropolitan Area Network (MAN)), a WiFi device, a WiMax device, a cellular communication device, etc.), and/or the like. The communication unit 408 may permit data to be exchanged with a network and/or any other devices or systems, such as those described in the present disclosure.

The operating system 410 may be configured to manage hardware and software resources of the computer system 400 and configured to provide common services for the computer system 400.

The user interface 412 may include any device configured to allow a user to interface with the computer system 400. For example, the user interface 412 may include a display, such as an LCD, LED, or other display, that is configured to present video, text, application user interfaces, and other data as directed by the processor 402. The user interface 412 may further include a mouse, a track pad, a keyboard, a touchscreen, volume controls, other buttons, a speaker, a microphone, a camera, any peripheral device, or other input or output device. The user interface 412 may receive input from a user and provide the input to the processor 402. Similarly, the user interface 412 may present output to a user.

The application 414 may be one or more computer-readable instructions stored on one or more non-transitory computer-readable media, such as the memory 404 or the file system 406, that, when executed by the processor 402, is configured to perform one or more of the actions of the methods disclosed herein. In some embodiments, the application 414 may be part of the operating system 410 or may be part of an application of the computer system 400, or may be some combination thereof. In some embodiments, the application 414 may function as any one of the communication applications 112a-112n, 122a-122n, 126, and 130, or security application 200 of FIGS. 1 and 2.

Modifications, additions, or omissions may be made to the computer system 400 without departing from the scope of the present disclosure. For example, although each is illustrated as a single component in FIG. 4, any of the components 402-414 of the computer system 400 may include multiple similar components that function collectively and are communicatively coupled. Further, although illustrated as a single computer system, it is understood that the computer system 400 may include multiple physical or virtual computer systems that are networked together, such as in a cloud computing environment, a multitenancy environment, or a virtualization environment.

As indicated above, the embodiments described herein may include the use of a special purpose or general purpose computer (e.g., the processor 402 of FIG. 4) including various computer hardware or software applications, as discussed in greater detail below. Further, as indicated above, embodiments described herein may be implemented using computer-readable media (e.g., the memory 404 or file system 406 of FIG. 4) for carrying or having computer-executable instructions or data structures stored thereon.

In some embodiments, the different components and applications described herein may be implemented as objects or processes that execute on a computing system (e.g., as separate threads). While some of the methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely example representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the summary, detailed description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

The foregoing description, for purpose of explanation, has been described with reference to specific embodiments. However, the illustrative discussions above are not intended to be exhaustive or to limit the invention as claimed to the precise forms disclosed. Many modifications and variations are possible in view of the above teachings. The embodiments were chosen and described to explain practical applications, to thereby enable others skilled in the art to utilize the invention as claimed and various embodiments with various modifications as may be suited to the particular use contemplated.

1. A computer-implemented method for identifying accurate locations of in-person payment card transactions to detect location-based payment card anomalies, at least a portion of the method being performed by a computing device comprising one or more processors, the method comprising:
receiving purchase data for a new financial transaction by a consumer with a merchant that is performed in-person with a payment card, wherein the purchase data identifies the merchant and a merchant location that is associated with the new financial transaction;
receiving merchant data that includes a number of locations where the merchant transacts business and historical financial transaction data with the merchant, wherein the historical financial transaction data identifies a location, within the number of locations, where each historical financial transaction is reported to have been performed;
selecting, from the merchant data, a number of historical financial transactions to determine a frequency at which historical financial transactions are reported to have been performed at the merchant location that is associated with the new financial transaction;
calculating a probability that the merchant location that is associated with the new financial transaction is a true physical location of the new financial transaction, wherein the probability calculation uses the frequency at which the historical financial transactions are reported to have been performed at the merchant location that is associated with the new financial transaction and a probability value that is based, at least in part, on the number of locations where the merchant transacts business; and
determining that the merchant location that is associated with the new financial transaction is the true physical location of the new financial transaction when the probability calculated is more than an identified probability threshold.

2. The method of claim 1, wherein the purchase data includes an “isPhysical” bit and the new financial transaction is determined to be in-person based on a positive “isPhysical” bit.

3. The method of claim 1, wherein the merchant location within the purchase data and the number of locations where each historical financial transaction is reported to have been performed within the merchant data are identified by at least one of a state, a city, or a zip code.

4. The method of claim 1, wherein the probability value weighs each of the number of locations where the merchant transacts business equally so that there is an equal probability that a transaction occurs at each of the locations where the merchant transacts business.

5. The method of claim 1, wherein the probability value for each of the locations where the merchant transacts business is adjusted to account for a population density of each location within the number of locations where the merchant transacts business.

6. The method of claim 1, wherein the probability calculation uses a binomial cumulative distribution function to calculate the probability that the merchant location that is associated with the new financial transaction is the true physical location of the new financial transaction.

7. The method of claim 1, wherein when the probability calculated is less than the identified threshold, the method further comprises:
receiving consumer data for a plurality of individuals that have performed an historical in-person financial transaction with the merchant, wherein the consumer data includes a reported location of non-merchant in-person financial transactions that the plurality of individuals performed on the same day as the historical financial transaction with the merchant;
calculating, from the consumer data, a fraction of the non-merchant financial transactions that the plurality of individuals performed on the same day as the historical financial transaction with the merchant that have a reported location that is the same as the merchant location that is associated with the new financial transaction; and
determining that the merchant location that is associated with the financial transaction is the true physical location of the financial transaction when the fraction calculated is more than an identified fraction threshold.

8. The method of claim 1, further comprising:
determining true physical locations for a plurality of financial transactions performed by the consumer in a single day;
determining a distance between the true physical locations for the plurality of financial transactions; and
performing a security action if the distance between two or more financial transactions within the plurality of financial transactions exceeds an identified distance threshold.

9. The method of claim 8, wherein the security action is providing an alert to the consumer or placing a hold on one or more of the consumer's payment cards.

10. A computer-implemented method for identifying accurate locations of in-person payment card transactions to detect location-based payment card anomalies, at least a portion of the method being performed by a computing device comprising one or more processors, the method comprising:
receiving purchase data for a new financial transaction by a consumer with a merchant that is performed in-person with a payment card, wherein the purchase data identifies the merchant and a merchant location that is associated with the new financial transaction;
receiving consumer data for a plurality of individuals that have performed an historical in-person financial transaction with the merchant, wherein the consumer data includes a reported location of non-merchant in-person financial transactions that the plurality of individuals performed on the same day as the historical financial transaction with the merchant;
calculating, from the consumer data, a fraction of the non-merchant financial transactions that the plurality of individuals performed on the same day as the historical financial transaction with the merchant that have a reported location that is the same as the merchant location that is associated with the new financial transaction; and
determining that the merchant location that is associated with the financial transaction is the true physical location of the financial transaction when the fraction calculated is more than an identified fraction threshold.

11. The method of claim 10, wherein the purchase data includes an “isPhysical” bit and the new financial transaction is determined to be in-person based on a positive “isPhysical” bit.

12. The method of claim 10, wherein the merchant location within the purchase data and the reported location of non-merchant in-person financial transactions for the plurality of individuals are identified by at least one of a state, a city, or a zip code.

13. The method of claim 10, further comprising:
determining true physical locations for a plurality of financial transactions performed by the consumer in a single day;
determining a distance between the true physical locations for the plurality of financial transactions; and
performing a security action if the distance between two or more financial transactions within the plurality of financial transactions exceeds an identified distance threshold.

14. The method of claim 13, wherein the security action is providing an alert to the consumer or placing a hold on one or more of the consumer's payment cards.

15. A computer-implemented method for identifying accurate locations of in-person payment card transactions to detect location-based payment card anomalies, at least a portion of the method being performed by a computing device comprising one or more processors, the method comprising:
(a) receiving purchase data for a first financial transaction by a consumer with a merchant that is performed in-person with a payment card, wherein the purchase data identifies the merchant, a merchant location that is associated with the first financial transaction, and a date on which the first financial transaction occurred;
(b) receiving merchant data that includes a number of locations where the merchant transacts business and historical financial transaction data with the merchant, wherein the historical financial transaction data identifies a location, within the number of locations, where each historical financial transaction is reported to have been performed;
(c) selecting, from the merchant data, a number of historical financial transactions to determine a frequency at which historical financial transactions are reported to have been performed at the merchant location that is associated with the first financial transaction;
(d) calculating a probability that the merchant location that is associated with the first financial transaction is a true physical location of the first financial transaction, wherein the probability calculation uses the frequency at which the historical financial transactions are reported to have been performed at the merchant location that is associated with the first financial transaction and a probability value that is based, at least in part, on the number of locations where the merchant transacts business;
(e) receiving consumer data for a plurality of individuals that have performed an historical in-person financial transaction with the merchant, wherein the consumer data includes a reported location of non-merchant in-person financial transactions that the plurality of individuals performed on a same day as the historical financial transaction with the merchant;
(f) calculating, from the consumer data, a fraction of the non-merchant financial transactions that the plurality of individuals performed on the same day as the historical financial transaction with the merchant that have a reported location that is the same as the merchant location that is associated with the first financial transaction;
(g) determining that the merchant location that is associated with the first financial transaction is the true physical location of the first financial transaction if the probability calculated is more than an identified probability threshold or the fraction calculated is more than an identified fraction threshold;
(h) repeating steps (a)-(g) for a second financial transaction by the consumer with another merchant that is performed in-person with the payment card on the date on which the first financial transaction occurred to determine a true physical location for the second financial transaction;
(i) determining a distance between the true physical locations of the first and second financial transactions; and
(j) performing a security action if the distance between the true physical locations of the first and second financial transactions exceeds an identified distance threshold.

16. The method of claim 15, wherein the purchase data includes an “isPhysical” bit and the new financial transaction is determined to be in-person based on a positive “isPhysical” bit.

17. The method of claim 15, wherein the probability value weighs each of the number of locations where the merchant transacts business equally so that there is an equal probability that a transaction occurs at each of the locations where the merchant transacts business.

18. The method of claim 15, wherein the probability value for each of the locations where the merchant transacts business is adjusted to account for a population density of each location within the number of locations where the merchant transacts business.

19. The method of claim 15, wherein the probability calculation uses a binomial cumulative distribution function to calculate the probability that the merchant location that is associated with the new financial transaction is the true physical location of the new financial transaction.

20. The method of claim 19, wherein the security action is providing an alert to the consumer or placing a hold on one or more of the consumer's payment cards.
